(19) United States
(12) Patent Application Publication
(10) Pub. No.: US 2026/0089298 A1
(43) Pub. Date: Mar. 26, 2026

(54) PROJECTION METHOD, PROJECTION SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventor: Daisuke SAWAKI, SHIOJIRI-SHI (JP)

(21) Appl. No.: 19/332,469

(22) Filed: Sep. 18, 2025

(30) Foreign Application Priority Data
Sep. 20, 2024 (JP) 2024-163603

(51) Int. Cl. H04N 9/31; G03B 31/00

(52) U.S. Cl. CPC H04N 9/3185; G03B 31/00; H04N 9/3194

(57) ABSTRACT

A projection system of the present disclosure includes a projector and an information processing device that controls the projector. The information processing device generates correction data obtained by correcting image data based on positional information indicating a positional relationship between the projector and a projection target and shape information indicating a shape of the projection target. Subsequently, the information processing device generates content image data corresponding to a content image with an image generation AI model to which designation information designating a mode of the content image and the correction data are input. Then, the information processing device causes the projector to project the content image based on the content image data as the image data onto the projection target.

The present application is based on, and claims priority from JP Application Serial Number 2024-163603, filed Sep. 20, 2024, the disclosure of which is hereby incorporated by reference herein in its entirety.

### BACKGROUND

### 1. Technical Field

The present disclosure relates to a projection method, a projection system, and a non-transitory computer-readable storage medium storing a program.

### 2. Related Art

JP-A-2023-118230 discloses an image generation method for generating a projection image to be projected from a projector onto a projection target. In the image generation method disclosed in JP-A-2023-118230, an information processing device that supplies projection image data representing the projection image to the projector causes the projector to project a pattern image for three-dimensional measurement onto the projection target. The information processing device generates the projection image data representing the projection image by correcting a material image according to a three-dimensional shape measured based on a captured image obtained by imaging, from a determined position, with a camera, the projection target onto which the pattern image for the three-dimensional measurement is projected.

JP-A-2023-118230 is an example of the related art.

The material image in JP-A-2023-118230 is prepared in advance. In recent years, it has been demanded to further enhance artistic properties in projection mapping. However, the technique disclosed in JP-A-2023-118230 has not sufficiently met this demand.

### SUMMARY

According to an aspect of the present disclosure, there is provided a projection method including: generating correction data obtained by correcting image data based on positional information indicating a positional relationship between a projector and a projection target and shape information indicating a shape of the projection target; generating content image data corresponding to a content image with a first image generation AI model to which designation information designating a mode of the content image and the correction data are input; and projecting the content image based on the content image data serving as the image data from the projector onto the projection target.

According to an aspect of the present disclosure, there is provided a projection system including: a projector; and a processing device configured to control the projector, the processing device executes: generating correction data obtained by correcting image data based on positional information indicating a positional relationship between a projector and a projection target and shape information indicating a shape of the projection target; generating content image data corresponding to a content image with a first image generation AI model to which designation information designating a mode of the content image and the correction data are input; and projecting the content image based on the content image data serving as the image data from the projector onto the projection target.

According to an aspect of the present disclosure, there is provided a non-transitory computer-readable storage medium storing a program, the program causing a computer to execute: generating correction data obtained by correcting image data based on positional information indicating a positional relationship between a projector and a projection target and shape information indicating a shape of the projection target; generating content image data corresponding to a content image with a first image generation AI model to which designation information designating a mode of the content image and the correction data are input; and projecting the content image based on the content image data serving as the image data from the projector onto the projection target.

### BRIEF DESCRIPTION OF THE DRAWINGS

FIG. 1 is a diagram illustrating a configuration example of a projection system according to an embodiment of the present disclosure.

FIG. 2 is a diagram illustrating an example of a projection target onto which a content image is projected from a projector.

FIG. 3 is a block diagram illustrating a configuration example of an information processing device provided in the projection system.

FIG. 4 is a diagram illustrating an example of a base image.

FIG. 5 is a diagram illustrating an example of a base image for generation.

FIG. 6 is a diagram illustrating an example of a content image and individual objects extracted from the content image.

FIG. 7 is a diagram illustrating an example of an effect.

FIG. 8 is a diagram illustrating an example of an effect.

FIG. 9 is a diagram illustrating an example of an effect.

FIG. 10 is a flowchart illustrating a flow of processing in a projection method executed by a processing device of the information processing device.

FIG. 11 is a flowchart illustrating a flow of processing in content image generation processing.

### DESCRIPTION OF EMBODIMENTS

Various technically preferable limitations are added to an embodiment explained below. However, embodiments of the present disclosure are not limited to the embodiment explained below.

### A. Embodiment

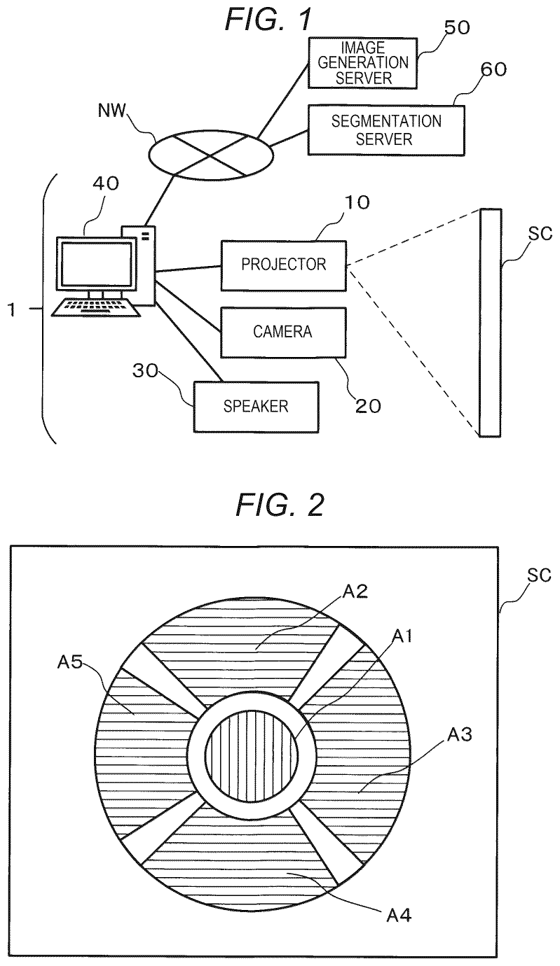

FIG. 1 is a diagram illustrating a configuration example of a projection system 1 according to an embodiment of the present disclosure. The projection system 1 includes a projector 10 that projects an image onto a projection target SC, a camera 20, a speaker 30, and an information processing device 40. As illustrated in FIG. 1, each of the projector 10, the camera 20, and the speaker 30 is connected to the information processing device 40 by wire or radio. The information processing device 40 is connected to a communication network NW such as the Internet by wire or radio. An image generation server 50 and a segmentation server 60 are connected to the communication network NW. The information processing device 40 communicates with each of the image generation server 50 and the segmentation server 60 via the communication network NW.

FIG. 2 is a diagram illustrating an example of the projection target SC in the present embodiment. The projection target SC in the present embodiment is, for example, a wall surface of a room and has unevenness. The projection target SC includes a portion A1 formed in a circular shape and protruding to the front and portions A2 to A5 located around the portion AI, respectively formed in arc shapes, and recessed to the inner side. In FIG. 2, the portion A1 protruding to the front side is hatched with vertical lines and each of the portions A2 to A5 recessed to the inner side is hatched with horizontal lines. The projector 10, the camera 20, the speaker 30, and the information processing device 40 are installed in a room in which a wall surface is the projection target SC. The projection target SC may be a plane or may be a three-dimensional object having a three-dimensional shape.

The projector 10 includes a generator that generates image light corresponding to image data provided from the outside and an optical system that guides the image light generated by the generator to the projection target SC. In FIG. 1, the generator and the optical system are not illustrated. Specific examples of the generator include a drawing panel including a light modulation element such as a liquid crystal display (LCD), a liquid crystal on silicon (LCOS), or a digital micromirror device (DMD). The optical system includes, for example, a projection lens and a spectral prism.

The camera 20 includes a CMOS (Complementary Metal-Oxide-Semiconductor) or CCD (Charge Coupled Device) image sensor. In the present embodiment, an imaging region of the camera 20 is set in advance to include the entire projection target SC. The camera 20 images the imaging region under the control by the information processing device 40. The camera 20 outputs image data representing a captured image to the information processing device 40. A sound signal is given to the speaker 30 from the information processing device 40. The speaker 30 outputs sound, a sound wavemode of which is represented by the sound signal given from the information processing device 40.

The image generation server 50 includes an image generation artificial intelligence (AI) model. The image generation AI model in the present embodiment receives input of first data that is image data representing an original image and second data representing a motif or the like of a generation target image and generates output image data representing a new image by, for example, changing, based on the second data, the image represented by the first data. The image generation server 50 receives the input of the first data and the second data via the communication network NW and returns the generated output image data to a transmission source of the first data and the second data. The image generation AI model included in the image generation server 50 is an example of a first image generation AI model in the present disclosure.

The segmentation server 60 is a device that executes segmentation processing. The segmentation processing refers to dividing an image into a plurality of regions and grouping a plurality of regions having the same meaning of an image. The segmentation server 60 performs the segmentation processing on an image represented by image data received from the information processing device 40 via the communication network NW and returns image data representing images of regions classified, that is, grouped, by the segmentation processing to the information processing device 40.

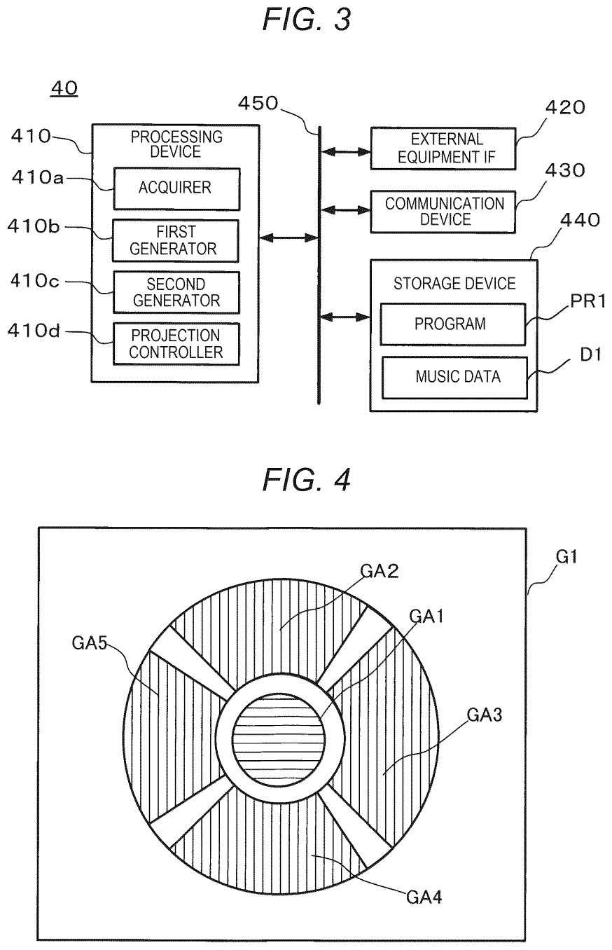

The information processing device 40 is, for example, a personal computer. FIG. 3 is a block diagram illustrating a configuration example of the information processing device 40. As illustrated in FIG. 3, the information processing device 40 includes a processing device 410, an external equipment interface (hereinafter, IF) 420, a communication device 430, a storage device 440, and a bus 450 that mediates data exchange among these elements. Besides the processing device 410, the external equipment IF 420, the communication device 430, the storage device 440, and the bus 450, the information processing device 40 includes a display device that displays various images under the control by the processing device 410 and an input device that receives operation by a user and gives operation content data representing content of the operation to the processing device 410. The display device and the input device are not illustrated in FIG. 3 because the devices are less relevant to the present disclosure. The processing device 410 includes one or a plurality of processors. The processor is, for example, a computer such as a central processing unit (CPU). As explained in detail below, the processing device 410 operates according to a program PR1 stored in advance in the storage device 440 to thereby function as a control center of the information processing device 40.

The external equipment IF 420 includes an interface circuit for connecting other equipment by wire or radio. Specific examples of the external equipment IF 420 include a USB interface. The projector 10, the camera 20, and the speaker 30 are connected to the external equipment IF 420 by wire or radio. The external equipment IF 420 communicates with the camera 20 to thereby receive image data transmitted from the camera 20. The external equipment IF 420 passes the image data received from the camera 20 to the processing device 410. The external equipment IF 420 communicates with the projector 10 to thereby transmit the image data given from the processing device 410 to the projector 10. The external equipment IF 420 converts sound data (a sample sequence obtained by sampling a sound waveform) given from the processing device 410 into a sound signal and outputs the sound signal obtained by the conversion to the speaker 30.

The communication device 430 is connected to the communication network NW by wire or radio. The communication device 430 is a communication interface circuit that transmits and receives data to and from other devices connected to the communication network NW. Examples of the other devices that transmit and receive data to and from the communication device 430 via the communication network NW include the image generation server 50 and the segmentation server 60 explained above.

The storage device 440 includes a nonvolatile memory such as a flash read only memory (ROM) and a volatile memory such as a random access memory (RAM). The nonvolatile memory of the storage device 440 stores the program for causing the processing device 410 to function as the control center of the information processing device 40 and music data D1 that is sampling data of music reproduced in synchronization with projection of projection content from the projector 10 onto the projection target SC. The nonvolatile memory of the storage device 440 is used by the processing device 410 as a work area when executing the program PR1.

When a power supply (not illustrated in FIG. 3) of the information processing device 40 is turned on and the execution of the program PR1 is instructed by operation of the user on the input device, the processing device 410 reads the program PR1 to the volatile memory from the nonvolatile memory. Then, the processing device 410 starts executing the program PR1 read to the volatile memory. The processing device 410 operating according to the program PR1 functions as an acquirer 410a, a first generator 410b, a second generator 410c, and a projection controller 410d. That is, each of the acquirer 410a, the first generator 410b, the second generator 410c, and the projection controller 410d illustrated in FIG. 2 is a software module implemented by causing the computer to operate according to the program PR1. Roles played by each of the acquirer 410a, the first generator 410b, the second generator 410c, and the projection controller 410d are as follows.

The acquirer 410a acquires positional information indicating a positional relationship between the projector 10 and the projection target SC and shape information indicating a three-dimensional shape of the projection target SC. In the present embodiment, the acquirer 410a controls the projector 10 to thereby cause the projector 10 to sequentially project a plurality of measurement patterns (for example, grayscale periodic patterns) different from one another onto the projection target SC. The acquirer 410a causes the camera 20 to capture, for each of the measurement patterns, an image including the projection target SC in a state in which the measurement pattern is projected and acquires image data representing captured images from the camera 20. The acquirer 410a analyzes a plurality of pieces of image data acquired from the camera 20 to thereby calculate the shape information indicating the three-dimensional shape of the projection target SC and positional information indicating relative positions of the projection target SC and the projector 10. The positional information includes, for example, at least one of a rotation matrix and a position vector of the projection target SC with respect to the projector 10 (a projection lens). The acquirer 410a may acquire internal parameters of the projector 10, internal parameters of the camera 20, and external parameters indicating a positional relationship between the camera 20 and the projector 10. Information indicating the positional relationship between the camera 20 and the projector 10 includes, for example, at least one of a rotation matrix and a position vector of the projector 10 with respect to the camera 20. A well-known three-dimensional measurement technique only has to be used as appropriate for the calculation of the shape information and the positional information based on the captured images of the projection target SC onto which the plurality of measurement patterns are sequentially projected. The acquirer 410a may acquire measurement data measured by the user in advance rather than acquiring the shape information and the positional information with the three-dimensional measurement in which the plurality of measurement patterns are used. For example, the shape information may be 3D model data of the projection target SC and the positional information may be data indicating an actual measurement value of an inclination angle or a distance between the projector 10 and the projection target SC in a real space.

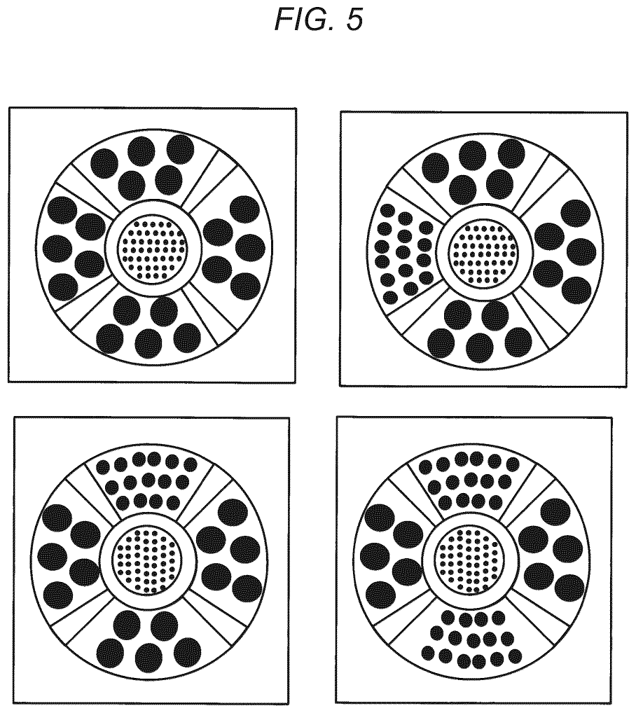

The first generator 410b generates base image data representing a base image based on the shape information acquired by the acquirer 410a and the positional information also acquired by the acquirer 410a. The base image refers to a projection image (data of the projection image) in which, when it is assumed that an image is projected from the projector 10 present at a position indicated by the positional information based on the position of the projection target SC, the shape of a two-dimensional image of the projection target SC is corrected to match a three-dimensional shape indicated by the shape information. Data of an image before the shape of the two-dimensional image of the projection target SC is corrected is an example of image data in the present disclosure. The base image data is an example of a concept of correction data in the present disclosure. The base image, that is, the two-dimensional image of the projection target SC is an image obtained by converting the three-dimensional shape of the projection target SC into a two-dimensional shape of a visual point of the projector 10. That is, the base image is, for example, a two-dimensional image of the projection target SC obtained by converting a two-dimensional image of the projection target SC viewed from the camera 20 into a visual point of the projector 10 based on the positional information and the shape information. The visual point of the projector 10 is, for example, a visual point viewed from the principal point of the projection lens. By converting to the visual point of the projector 10, when an image is actually projected from the projector 10, the image can be associated with the projection target SC having a substantially three-dimensional shape. The base image may be an image obtained by correcting the shape of a separately prepared two-dimensional image rather than the two-dimensional image of the projection target SC. When the base image is a separately prepared image, it is preferable that the image has design matching the three-dimensional shape of the projection target SC. When the base image is the image obtained by correcting the shape of the separately prepared two-dimensional image, the separately prepared two-dimensional image is another example of the image data in the present disclosure. FIG. 4 is a diagram illustrating an example of a base image G1. As illustrated in FIG. 4, the base image G1 includes a region GA1 corresponding to the portion A1 and regions GA2 to GA5 respectively corresponding to the portions A2 to A5 in a one-to-one relation. In FIG. 4, as in FIG. 2, a region that appears to protrude to the front side is hatched with vertical lines and a region that appears to be recessed to the inner side is hatched with horizontal lines. As it is evident when FIG. 4 and FIG. 2 are compared, unevenness is opposite in the base image and the projection target SC.

Subsequently, based on the base image data, the first generator 410b generates a plurality of pieces of base image data for generation respectively corresponding to a plurality of base images for generation in a one-to-one relation. Each of the plurality of base images for generation is a modulation image in which at least one parameter defining a mode of the base image is different from that of the base image. The plurality of base images for generation are another example of the concept of the correction data in the present disclosure and is further an example of a plurality of pieces of modulation image data in the present disclosure. The first generator 410b divides the base image into a plurality of regions by transmitting the base image data to the segmentation server 60 and generates one base image for generation by arranging grayscale patterns in the regions. The grayscale pattern represents a tone in the base image and represents a sense of depth in the base image. In the present embodiment, the at least one parameter is a tone. The at least one parameter may be a parameter defining a mode of the base image, such as an edge shape of the base image. The first generator 410b generates a plurality of base images for generation by adjusting, for each of the regions, as appropriate, grayscales arranged in the regions. FIG. 5 is a diagram illustrating an example of a plurality of base images for generation in the present embodiment. The plurality of base images for generation may be generated directly using the base image or may be generated using a shaped base image obtained by shaping, with a Bezier curve or the like, a side indicating an outer shape in the base image. In FIG. 5, a grayscale is represented by a black circle and, as the black circle is larger, the tone is lower and the base image is further recessed to the inner side. When the grayscales arranged in the regions are adjusted for each of the regions, a base image for generation, a sense of depth of which does not always match the shape of the projection target SC is obtained. However, but this mismatch is sometimes a fun of a content image.

The second generator 410c generates, based on the respective plurality of base images for generation, a plurality of pieces of content image data corresponding to, in a one-to-one relation, the respective plurality of content images sequentially projected onto the projection target SC. More specifically, first, the second generator 410c causes the display device to display a UI screen for urging the user to input text data designating a mode of a content image with a word (a natural language or a prompt) and receives input of the text data by operation on the input device. The user inputs a word constituting a content image that the user images. This word may be a word designating a specific object such as a dog or a cat or may be a word abstractly designating a composition of a content image such as a color or a style of painting. If the word is the same, content images slightly different from one another are obtained in a range of expression of a meaning of the word. The text data is an example of designation information in the present disclosure. The designation information may be voice data or image data rather than the text data. The designation information may be a combination of at least any two of the text data, the voice data, and the image data. The second generator 410c may receive input of not only one piece of text data but also a plurality of pieces of text data.

The second generator 410c repeatedly executes, N times (N is a predetermined integer of 2 or more), processing of transmitting the text data to the image generation server 50 as the first data explained above and transmitting any one of the plurality of pieces of base image data for generation to the image generation server 50. Then, the second generator 410c generates a plurality of pieces of content image data by acquiring, as content image data, respective N pieces of output image data returned from the image generation server 50. That is, the plurality of pieces of content image data are generated by the image generation AI model of the image generation server 50.

The second generator 410c generates interpolation content image data corresponding to an intermediate image, which is an image between two content images arranged in front and behind in a row of the plurality of content images, using the image generation AI like the content image data. Of the two content images arranged in front and behind in the row of the plurality of content images, the content image data representing the content image projected first is an example of first content image data in the present disclosure and the content image data representing the content image projected subsequently is an example of second content image in the present disclosure. The interpolation content image data is data for, when a plurality of content images are sequentially reproduced as moving images, reproducing the moving images with discontinuity reduced.

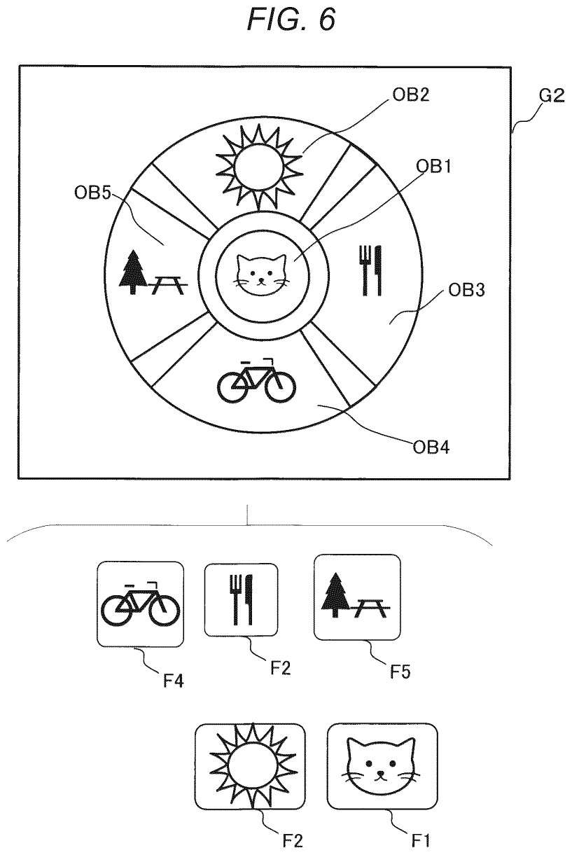

The second generator 410c transmits image data respectively representing the plurality of content images and the interpolation content image to the segmentation server 60 to thereby recognize semantically the same regions in the images and writes the images of the respective regions in the storage device 440 as files. For example, it is assumed that text data including words such as “fine”, “park”, “bicycle”, “lunch box”, and “cat” is input as the text data explained above and an image G2 illustrated in FIG. 6 is generated as a content image. As illustrated in FIG. 6, the image G2 is an image obtained by arranging individual objects OB1 to B5 in the respective regions GA1 to GA5 in the base image for generation. The individual object OB1 is an image of a “cat”. The individual object OB2 is an image of a “fine weather”. The individual object OB3 is an image of “lunch box”. The individual object OB4 is an image of a “bicycle”. The individual object OB5 is an image of “park”. The second generator 410c recognizes individual objects the included in image G2 using segmentation processing and writes individual files F1 to F5 (see FIG. 6) respectively corresponding to the individual objects OB1 to B5 in the storage device 440. The plurality of content images and the interpolation content image are decomposed into the individual objects and stored in order to reduce a processing load when applying effects explained below.

The projection controller 410d reads the individual files explained above from the storage device 440 at the opportunity when operation for instructing a projection start of a content image is performed on the input device, edits image data based on the individual files, and supplies the image data to the projector 10 to thereby cause the projector 10 to project the content image onto the projection target SC.

The projection controller 410d reads the music data D1 from the storage device 440 at the opportunity when the operation for instructing the projection start of the content image is performed on the input device and supplies a sound signal corresponding to the music data D1 to the speaker 30 via the external equipment IF 420. At this time, the projection controller 410d detects, in real time, changes in speed and sound pressure of music reproduced according to the music data D1 and applies one of or a combination of an effect A and an effect B explained below to a content image projected onto the projection target SC. The effect A is an effect applied to the content image according to the speed of the music reproduced according to the music data D1 and the effect B is an effect applied to the content image according to the change in the sound pressure in the music reproduced according to the music data D1 (a sound pressure change of sound generation of a percussion, a lead guitar or vocalization, or the like).

### (A) Effect A

Specific examples of the effect A include applying a fisheye lens effect. The fisheye lens effect is implemented by image processing of giving a three-dimensional curvature centering on an image center with respect to an entire projection image. The curvature is represented as a function of an elapsed time from a point in time when the fisheye lens effect is started to be applied. A cycle of a curvature change may coincide with the speed of music (BPM: Beat Per Minute) reproduced at the point in time when the fisheye lens effect is applied or may be N times or 1/N times the BPM. Note that N is an integer of 2 or more.

### (B) Effect B

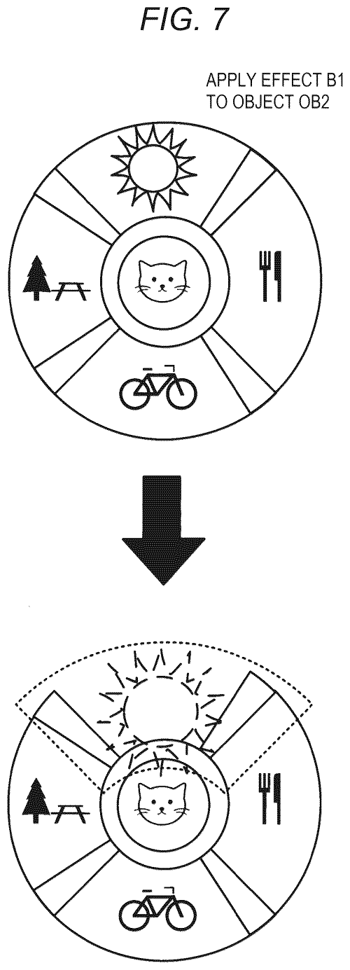

Specific examples of the effect B include enlargement of an individual object (hereinafter, an effect B1). As illustrated in FIG. 7, the enlargement of the individual object refers to enlarging the size of the individual object according to an elapsed time from a point in time when applying of the effect is started in a state in which a center coordinate of the individual object with respect to a content image is maintained. FIG. 7 illustrates an example in which the effect B1 is applied to the individual object OB2. Since the individual object overlaps another adjacent individual object when the individual object is enlarged, in order to prevent the other individual object from becoming unseen, processing of increasing the transparency of the individual object with the elapse of time according to the enlargement of the individual object may be included. In FIG. 7, a state in which the transparency is increased is illustrated by drawing the individual object OB1 with a dotted line.

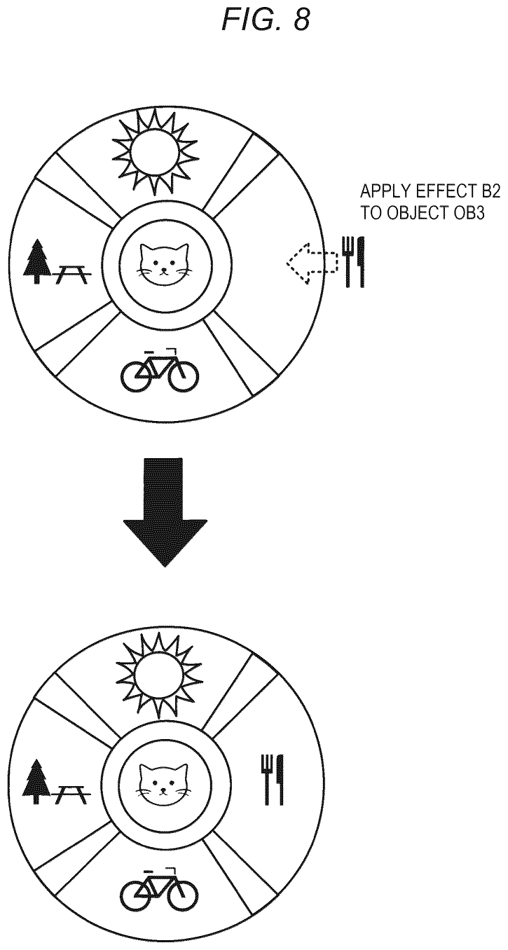

Other specific examples of the effect B include movement of the individual object (hereinafter, effect B2). As illustrated in FIG. 8, the movement of the individual object refers to an object moving the individual object from the outer periphery of the content image toward a drawing position of the individual object in the content image. FIG. 8 illustrates an example in which the effect B2 is applied to the individual object OB3. More specifically, a straight line passing a center coordinate of the content image and a coordinate of the drawing position of the individual object only has to be set as a track of the movement of the individual object and a start position of the movement only has to be determined at a radius of a circle having the center coordinate of the content image as the center. The moving speed only has to be determined by the BPM of the music and the moving speed only has to be determined such that the movement of the individual object is completed in one beat. Since the individual object overlaps another individual object during the movement of the individual object, in order to prevent the other individual object from becoming unseen, processing of making the movement target individual object transparent at the movement start time point and reducing the transparency of the individual object as time elapses may be included.

Still other specific examples of the effect B include a hue change of the individual object (hereinafter, effect B3). Specifically, the still other specific examples include sequentially rotating a hue of the individual object from a point in time when the applying of the effect is started up to 360° according to an elapsed time. For example, the hue of the individual object only has to turn around (rotates) 360° in one beat.

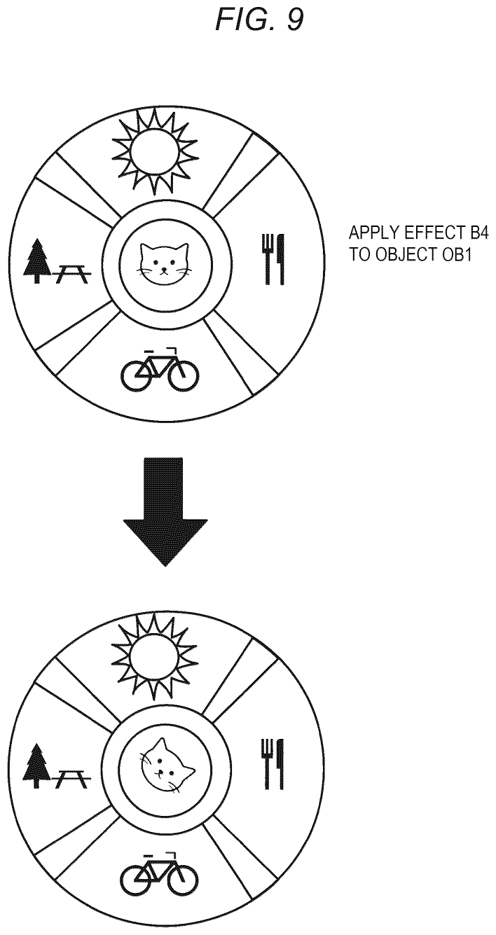

Still other specific examples of the effect B include rotation of the individual object (hereinafter, effect B4). The rotation of the individual object refers to, as illustrated in FIG. 9, setting the center position of the individual object in the content image as a rotation center and rotating the individual object within a screen plane in a designated angle range. FIG. 9 illustrates an example in which the effect B4 is applied to the individual object OB1. The individual object may be rotated to the plus side (for example, the clockwise direction) or the minus side (for example, the counterclockwise direction) in one bead and the number of times of each rotation may be pointed out.

Still other specific examples of the effect B include sequentially switching a created plurality of content images in units of content images (hereinafter, effect B5).

The effects B1 to B5 may be associated in advance with parts of the music reproduced according to the music data D1. For example, the effect B1 may be associated with a percussion part and the applying of the effect B1 may be implemented at the opportunity when a change in sound pressure of the percussion part is detected. Similarly, the effect B2 may be associated with a vocal part and the applying of the effect B2 may be implemented at the opportunity when a change in sound pressure of the vocal part is detected. Note that, in which part a change in sound pressure in the music reproduced according to the music data D1 has occurred only has to be specified based on, for example, a frequency distribution in sound, the sound pressure of which has changed. Although the music data D1 in the present embodiment is the sampling data representing the wavemode of the sound, the music data D1 may be MIDI (Musical Instrument Digital Interface) data describing sound generation (note-on) and sound attenuation (note-off) for each of parts. When the music data D1 is the MIDI data, it is easy to associate the effects B1 to B5 and the parts. The effects B1 to B5 may be associated with a composition of music. For example, the effect B1 may be associated with an A melody, the effect B2 may be associated with a B melody, and the effect B3 may be associated with a chorus.

The effects B1 to B5 may not be always applied at the point in time when the change in the sound pressure of the music reproduced according to the music data D1 occurs, and execution probabilities of the effects may be set for each of the effects and whether to execute the effects may be determined using a pseudo-random number of 0 or more and less than 1. Specifically, the projection controller 410d only has to generate the pseudorandom number every time the change in the sound pressure in the music reproduced according to the music data D1 is detected and execute applying of an effect having an execution probability equal to or higher than the pseudorandom number. The number of effects to be executed at a time at the point in time when the change in the sound pressure occurs in the music reproduced according to the music data D1 may be designated by the user in advance and, in this case, the projection controller 410d may select the designated number of effects out of the effects B1 to B5 using a pseudo-random number or the like every time the change in the sound pressure is detected in the music reproduced according to the music data D1. The number of individual objects to which the effects are applied may be designated in advance by the user.

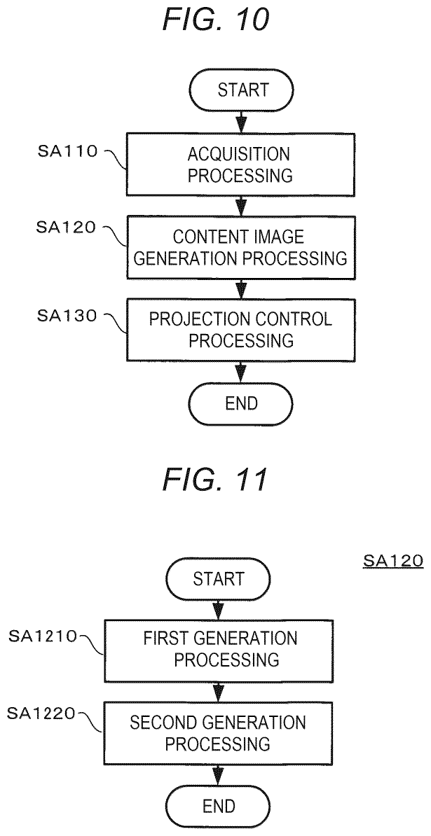

The processing device 410 operating according to the program PR1 executes a projection method for a content image markedly showing the characteristics of the present disclosure. FIG. 10 is a flowchart illustrating a flow of processing in the projection method.

In acquisition processing SA110, the processing device 410 operating according to the program PR1 functions as the acquirer 410a. In the acquisition processing SA110, the processing device 410 acquires positional information indicating the positional relationship between the projector 10 and the projection target SC and the shape information indicating a three-dimensional shape of the projection target SC. In the acquisition processing SA110, the processing device 410 controls the projector 10 to thereby cause the projector 10 to sequentially project a plurality of measurement patterns different from one another onto the projection target SC. The processing device 410 causes the camera 20 to capture, for each of measurement patterns, an image including the projection target SC in a state in which the measurement pattern is projected and acquires image data representing captured images from the camera 20. The processing device 410 then analyzes a plurality of pieces of image data acquired from the camera 20 to thereby calculate the shape information indicating a three-dimensional shape of the projection target SC and positional information indicating relative positions of the projection target SC and the projector 10.

Content image generation processing SA120 following the acquisition processing SA110 is processing of generating a content image to be projected onto the projection target SC from the projector 10. FIG. 11 is a flowchart illustrating a flow of processing in the content image generation processing SA120. As illustrated in FIG. 11, the content image generation processing SA120 includes first generation processing SA1210 and second generation processing SA1220.

In the first generation processing SA1210, the processing device 410 operating according to the program PR1 functions as the first generator 410b. In the first generation processing SA1210, the processing device 410 generates, based on the shape information and the positional information acquired in the acquisition processing SA110, base image data representing a base image. Subsequently, in the first generation processing SA1210, the processing device 410 generates, based on the generated base image data, a plurality of pieces of base image data for generation corresponding to a respective plurality of base images for generation in a one-to-one relation. In the present embodiment, the processing device 410 generates the plurality of base images for generation by performing a plurality of kinds of segmentation on a base projection image, arranging grayscale patterns in respective segments, and adjusting, for each of the segments, as appropriate, the grayscales arranged in the segments.

In the second generation processing SA1220 following the first generation processing SA1210, the processing device 410 operating according to the program PR1 functions as the second generator 410c. In the second generation processing SA1220, the processing device 410 first generates, based on the respective plurality of base images for generation generated in the first generation process SA1210, a plurality of pieces of content image data corresponding to the respective plurality of content images sequentially projected onto the projection target SC in a one-to-one relation. More specifically, the processing device 410 displays, on the display device, a UI screen for urging the user to input text data designating a mode of a content image with a word and receives the input of the text data by operation on the input device. Subsequently, the processing device 410 repeatedly executes, N times (N is a predetermined integer of 2 or more), processing of transmitting the text data to the image generation server 50 as the first data and transmitting any one of the plurality of pieces of base image data for generation to the image generation server 50. That is, the processing device 410 transmits the N pieces of base image data for generation to the image generation server 50. Then, the processing device 410 generates a plurality of pieces of content image data by acquiring, as content image data, each of N pieces of output image data returned from the image generation server 50. The processing device 410 generates interpolation content image data corresponding to an intermediate image, which is an image between two content images arranged in front and behind in a row of the plurality of content images, using an image generation AI model like the content image data. Then, the processing device 410 uses segmentation for each of the plurality of content images and the interpolation content image to thereby write images of respective regions in the storage device 440 as files.

The above is the flow of the processing in the content image generation processing SA120.

Referring back to FIG. 10, projection processing SA130 following the content image generation processing SA120 is processing executed at the opportunity when operation for instructing a start of projection of a content image is performed on the input device. In the projection processing SA130, the processing device 410 operating according to the program PR1 functions as the projection controller 410d. In the projection processing SA130, the processing device 410 executes, in parallel, processing of reading the individual files explained above from the storage device 440, editing image data based on the individual files, and supplying the edited image data to the projector 10 to thereby cause the projector 10 to project the content image onto the projection target SC and processing of reading the music data D1 from the storage device 440 and supplying a sound signal corresponding to the music data to the speaker 30 via the external equipment IF 420. The processing device 410 detects, in real time, changes in speed and sound pressure of music reproduced according to the music data D1 and applies any one of the effect A and the effects B1 to B5 or a combination of the effects to the content image projected onto the projection target SC.

As explained above, according to the present embodiment, it is possible to readily create, using the image generation AI model, a content image to be projected onto the projection target SC. In the present embodiment, data input to the image generation AI model is not image data itself but is correction data obtained by correcting the image data based on the positional information and the shape information. For this reason, according to the present embodiment, the content image projected onto the projection target SC is optimized according to the positional relationship between the projector 10 and the projection target SC and the shape of the projection target SC. According to the present embodiment, it is possible to project a highly artistic image suitable for projection mapping onto the projection target SC.

### B. Modifications

The embodiments explained above can be modified as explained below.

(1) The first data in the embodiment explained above is data defining the mode of the generation target image in the natural language. However, the first data may be any one of a photograph, sound data representing music or voice, or biometric information representing a pulse, a pupil, a line of sight, a blood pressure, or a heart rate of the user or may be a combination of any plurality of these.

(2) In the embodiment explained above, the music represented by the music data D1 is reproduced in synchronization with the projection of the content image onto the projection target SC. However, the reproduction of the music may be omitted. In the aspect in which the reproduction of the music is omitted, various effects may be applied to the content image according to an elapsed time from a start of the projection of the content image. The applying of the various effects to the content image is not essential and may be omitted. The generation of the interpolation content image in the embodiment explained above is not essential and may be omitted. An image generation AI model for generating interpolation content image data corresponding to the interpolation content image may be the same as or different from an image generation AI model for generating content image data. That is, the image generation AI model for generating the interpolation content image data is an example of a second image generation AI model in the present disclosure and the image generation AI model for generating the content image data is an example of the first image generation AI model in the present disclosure. At this time, the image generation server 50 may include the first image generation AI model and the second image generation AI model or the image generation server 50 may include the first image generation AI model and an image generation server different from the image generation server 50 may include the second image generation AI model.

(3) One or both of the camera 20 and the speaker 30 may be provided in the information processing device 40. The camera 20 may be provided in the projector 10. The image generation AI model may be stored in the storage device 440 of the information processing device 40. In the aspect in which the image generation AI model is stored in the storage device 440 of the information processing device 40, the information processing device 40 may also play the roles of the image generation server 50. The information processing device 40 may also play roles of a segmentation server.

(4) The acquirer 410a, the first generator 410b, the second generator 410c, and the projection controller 410d in the embodiment explained above are software modules. However, at least one of the acquirer 410a, the first generator 410b, the second generator 410c, and the projection controller 410d may be a hardware module such as an application specific integrated circuit (ASIC). Even if at least one of the acquirer 410a, the first generator 410b, the second generator 410c, and the projection controller 410d is the hardware module, the same effects as the effects of the embodiment explained above are achieved.

(5) The program PR1 may be manufactured alone and may be provided for a fee or free of charge. Specific aspects in providing the program PR1 include an aspect in which the program PR1 is provided by being written in a computer-readable recording medium such as a flash ROM and an aspect in which the program PR1 is provided by being downloaded through an electric communication line such as the Internet. Further, the information processing device 40 may function as an application service provider (ASP) server that provides a service of generating and returning content image data when positional information, shape information, and text data are received via the communication network NW.

### D: Summary of the Present Disclosure

The present disclosure is not limited to the embodiment and the modifications explained above and can be implemented in various aspects without departing from the gist of the present disclosure. For example, the present disclosure can also be implemented by the following aspects. Technical features in the embodiment explained above corresponding to technical features in the aspects described below can be replaced or combined as appropriate in order to solve a part or all of the problems of the present disclosure or in order to achieve a part or all of the effects of the present disclosure. The technical features can be deleted as appropriate unless described as essential features in the present specification.

A summary of the present disclosure is appended below.

### Appendix 1

According to an aspect of the present disclosure, there is provided a projection method including: generating correction data obtained by correcting image data based on positional information indicating a positional relationship between a projector and a projection target and shape information indicating a shape of the projection target; generating content image data corresponding to a content image with a first image generation AI model to which designation information designating a mode of the content image and the correction data are input; and projecting the content image based on the content image data serving as the image data from the projector onto the projection target. According to this aspect, since data input to the first image generation AI model is not the image data itself but the correction data obtained by correcting the image data based on the positional information and the shape information, the content image projected onto the projection target is optimized based on the positional information and the shape information. Therefore, according to this aspect, projection of a content image that is generated using the first image generation AI model and has high artistic properties more suitable for projection mapping is implemented.

### Appendix 2

A projection method according to a more preferable aspect is the projection method described in Appendix 1, in which the correction data is obtained by correcting the image data based on the positional information and the shape information and is a plurality of pieces of modulation image data indicating a plurality of modulation images whose at least one parameter defining a mode of a correction image indicated by the correction data is different from each other, the generating the content image data includes generating the content image data for the respective plurality of pieces of modulation image data with the first image generation AI model to which the designation information and the plurality of pieces of modulation image data are input, and the projecting the content image from the projector onto the projection target includes sequentially projecting a plurality of the content images based on a plurality of pieces of the content image data corresponding to the plurality of pieces of modulation image data in a one-to-one relation. According to this aspect, since the content image data is generated for the respective plurality of modulation image data, and the plurality of content images based on the plurality of pieces of content image data are sequentially projected, it is possible to provide a projection method for a content image further suitable for projection mapping.

### Appendix 3

A projection method according to a more preferable aspect is the projection method described in Appendix 2, in which the at least one parameter includes a tone of a correction image indicated by the correction data.

### Appendix 4

A projection method according to still another more preferable aspect is the projection method described in Appendix 2 or Appendix 3, in which the plurality of pieces of content image data include first content image data and second content image data, the generating the content image data includes generating, based on the first content image data and the second content image data, with the first image generation AI model or a second image generation AI model different from the first image generation AI model, interpolation content image data interpolated between the first content image data and the second content image data, and the projecting the content image from the projector onto the projection target includes sequentially projecting the content image based on the first content image data, the content image based on the interpolation content image data, and the content image based on the second content image data. According to this aspect, by projecting the interpolation content image data, it is possible to provide a projection method for a content image with less discomfort for a user.

### Appendix 5

A projection method according to still another more preferable aspect is the projection method described in Appendix 1, Appendix 2, Appendix 3, or Appendix 4, in which the generating the content image data includes: classifying the content image into a plurality of regions by applying segmentation processing to the content image; and generating image data corresponding to each of the plurality of regions. According to this aspect, since the image data corresponding to each of the plurality of regions obtained by performing segmentation on the content image is generated, the processing load when applying the effect to each region is reduced.

### Appendix 6

A projection method according to still another more preferable aspect is the projection method described in Appendix 1, Appendix 2, Appendix 3, Appendix 4, or Appendix 5, further including reproducing music in synchronization with the projection of the content image, in which the projecting the content image includes applying an effect corresponding to the music to the content image. According to this aspect, it is possible to reproduce music in synchronization with the projection of the content image and apply an effect corresponding to the music to the content image.

### Appendix 7

According to an aspect of the present disclosure, there is provided a projection system including: a projector; and a processing device configured to control the projector, the processing device executes: generating correction data obtained by correcting image data based on positional information indicating a positional relationship between a projector and a projection target and shape information indicating a shape of the projection target; generating content image data corresponding to a content image with a first image generation AI model to which designation information designating a mode of the content image and the correction data are input; and causing the projector to project the content image based on the content image data serving as the image data onto the projection target. According to this aspect, as in the projection method in Appendix 1, the projection of the content image generated using the first image generation AI model and having high artistic properties more suitable for the projection mapping is implemented.

### Appendix 8

According to an aspect of the present disclosure, there is provided a non-transitory computer-readable storage medium storing a program, the program causing a computer to execute: generating correction data obtained by correcting image data based on positional information indicating a positional relationship between a projector and a projection target and shape information indicating a shape of the projection target; generating content image data corresponding to a content image with a first image generation AI model to which designation information designating a mode of the content image and the correction data are input; and projecting the content image based on the content image data serving as the image data from the projector onto the projection target. According to this aspect, as in the projection method in Appendix 1, the projection of the content image generated using the first image generation AI model and having high artistic properties more suitable for the projection mapping is implemented.

What is claimed is:

1. A projection method comprising:
generating correction data obtained by correcting image data based on positional information indicating a positional relationship between a projector and a projection target and shape information indicating a shape of the projection target;
generating content image data corresponding to a content image with a first image generation AI model to which designation information designating a mode of the content image and the correction data are input; and
projecting the content image based on the content image data serving as the image data from the projector onto the projection target.

2. The projection method according to claim 1, wherein
the correction data is obtained by correcting the image data based on the positional information and the shape information and is a plurality of pieces of modulation image data indicating a plurality of modulation images whose at least one parameter defining a mode of a correction image indicated by the correction data is different from each other,
the generating the content image data includes generating the content image data for the respective plurality of pieces of modulation image data with the first image generation AI model to which the designation information and the plurality of pieces of modulation image data are input, and
the projecting the content image from the projector onto the projection target includes sequentially projecting a plurality of the content images based on a plurality of pieces of the content image data corresponding to the plurality of pieces of modulation image data in a one-to-one relation.

3. The projection method according to claim 2, wherein the at least one parameter includes a tone of a correction image indicated by the correction data.

4. The projection method according to claim 2, wherein
the plurality of pieces of content image data include first content image data and second content image data,
the generating the content image data includes generating, based on the first content image data and the second content image data, with the first image generation AI model or a second image generation AI model different from the first image generation AI model, interpolation content image data interpolated between the first content image data and the second content image data, and
the projecting the content image from the projector onto the projection target includes sequentially projecting the content image based on the first content image data, the content image based on the interpolation content image data, and the content image based on the second content image data.

5. The projection method according to claim 1, wherein the generating the content image data includes:
classifying the content image into a plurality of regions by applying segmentation processing to the content image; and
generating image data corresponding to each of the plurality of regions.

6. The projection method according to claim 1, further comprising reproducing music in synchronization with the projection of the content image, wherein
the projecting the content image includes applying an effect corresponding to the music to the content image.

7. A projection system comprising:
a projector; and
a processing device configured to control the projector,
the processing device executing:
generating correction data obtained by correcting image data based on positional information indicating a positional relationship between a projector and a projection target and shape information indicating a shape of the projection target;
generating content image data corresponding to a content image with a first image generation AI model to which designation information designating a mode of the content image and the correction data are input; and
causing the projector to project the content image based on the content image data serving as the image data onto the projection target.

8. A non-transitory computer-readable storage medium storing a program, the program causing a computer to execute:
generating correction data obtained by correcting image data based on positional information indicating a positional relationship between a projector and a projection target and shape information indicating a shape of the projection target;
generating content image data corresponding to a content image with a first image generation AI model to which designation information designating a mode of the content image and the correction data are input; and
causing the projector to project the content image based on the content image data serving as the image data onto the projection target.
